(19) United States
(12) Patent Application Publication
(10) Pub. No.: US 2003/0172191 A1
(43) Pub. Date: Sep. 11, 2003

(54) Coupling of CPU and disk drive to form a server and aggregating a plurality of servers into server farms

(76) Inventor: Joel R. Williams, San Jose, CA (US)

Correspondence Address: JOEL R. WILLIAMS, 1240 MCKENDRIE ST., SAN JOSE, CA, 95126, US

(21) Appl. No.: 10/081,801

(22) Filed: Feb. 22, 2002

(51) Int. Cl. G06F 15/16

(52) U.S. Cl. 709/253

(57) ABSTRACT

A system for coupling a disk drive to a CPU subsystem to produce a single server unit capable of providing network or other services. Further, a plurality of such server units may be aggregated to create server farms.

### BACKGROUND OF THE INVENTION

1. Technical Field

This invention relates generally to an apparatus and method for coupling a Central Processing Unit subsystem to a disk drive. Such combinations are found in a number of computer technologies including, but not limited to: network servers, multi-media players and compact personal computers. Furthermore, a plurality of servers may be aggregated into a system of servers called a server farm.

2. Description of the Prior Art

The standard personal computer typically includes at least a motherboard, a power supply, and a disk drive. The motherboard contains the main Central Processing Unit, referred to as a “CPU” hereafter, plus memory, disk controller, various additional components, as well as sockets to accommodate additional peripheral devices such as network interfaces. The disk controller interfaces to the disk drive in order to command the disk drive to read and write data and to facilitate moving the data to and from the disk drive. The disk drive is a self-contained unit consisting of the magnetic media, disk head assembly, and a dedicated micro-controller computer for controlling the low level operation of the disk. The disk drive and disk controller on the motherboard are connected together via a data cable. The power supply provides power to both the motherboard and disk driver via a power cable harness and standard connectors. This packaging design works well to provide flexible configuration options. However, it takes up considerable space and mounting hardware.

U.S. Pat. No. 4,908,715 entitled “Disk drive unit” by Krum et al. discloses a disk drive housing and a related circuit board. This circuit board serves the purpose of controlling the low-level disk functions and does not provide general purpose computing functions. It is intended to be used in a computer system having another CPU and containing additional disk controller electronics and related software capable of interacting with the functionality provided by the circuit board. This patent is representative of a number of similar inventions wherein the circuit board functions are exclusively for controlling the disk drive.

Some single board computers include a disk drive mounted directly on the circuit board such that the disk drive essentially becomes a component of the single board computer. In these designs, the main computer board extends under the disk drive, requiring special mounting hardware for the disk drive and preventing the resulting subsystem from fitting into typical standard disk drive mounting racks.

Network servers provide a variety of services over a network. They may be also referred to as Network Appliances. The services provided by these servers include, but are not limited to web servers, e-mail servers, database and application servers. Network servers are computer systems specially configured to provide these services.

A typical configuration consists of a rack-mounted computer that contains a CPU subsystem and a disk drive contained within the rack unit. One typical example is the Sun Microsystems Cobalt Raq™ 4 Server Appliance which suffers from a relatively large amount of wasted space and sheet metal used for housing the disk drive and CPU subsystem in one self contained enclosure that is then bolted into a rack. It further typically suffers from the need for a separate power supply and cooling fan contained within each rack unit.

Alternatively, a server farm of several servers may be composed of a rack shelf containing several single board computers coupled to a rack of disk drives. An example of these products can be found in ServTrends 1100-P unit manufactured by American MegaTrends Inc. located at 6145-F Northbelt Parkway Norcross, Ga. 30071-2976. This offers an improvement in storage space and total system cost because the CPU subsystems, contained on the single board computers, are co-located within one rack unit which affords the use of a common power supply and cooling fan set for the CPU subsystems. However, additional disk storage rack is needed to house the associated disk drives, often with its own power supply and cooling fans.

Single board servers combine both the CPU subsystem and the disk drive in one replaceable unit save additional space. A plurality of such servers fit into specially design enclosures and racks. However these servers do not fit into standard disk enclosures because their height and width is too large. An example of such a server is the ProLiant™ BL 10e Server Blade manufactured by Compaq Computer Corporation, P.O. Box 692000 Houston, Tex. 77269-2000.

Server farms often employ the well-known technology of Redundant Arrays of Independent Disks (RAID) in order to provide improved reliability and performance over single disk designs. In a RAID design, a number of disk drives are operated in a coordinated manner. They are typically connected via a control cable to the one CPU or perhaps a group of CPUs acting together. These CPUs are separate units from the RAID array of disks.

Another similar technology that is called Storage Area Network (SAN) in which multiple disk drives are connected to the CPU subsystem or systems by means of a network. This technology facilitates the communication between the disk drive and CPU subsystem. However, it does not provide a solution for communication between the CPU subsystem and the network over which service is provided to the users of the system.

### BRIEF SUMMARY OF THE INVENTION

It is the object of the present invention to provide economy of space and reduce system complexity by coupling the disk drive and the CPU subsystem together into one unit that is compatible with standard disk drive mounting hardware and enclosures. This facilitates construction of network servers that requires less space. For brevity, the combination of a CPU subsystem and disk drive into one unit will hence be referred to as a server.

It is a further object of the present invention to provide a server farm composed of these multiple servers that occupy less total rack space and may also utilize a common power supply and set cooling fans. One skilled in the art will readily recognize that this same advantage of aggregation of servers can be applied to any application where multiple servers may be co-located.

In the preferred embodiment, the disk drive is the same or similar to ones found in a PC computer and in many other computer systems. The disk drive contains a standard IDE (Integrated Device Electronics) or SCSI (Small Computer System Interface) data bus interface. This data bus interface connects to a disk controller and is used for controlling the operation of the disk and transferring data to and from the disk. This interface is hence referred to as the “data bus” for brevity. Such a disk drive typically has two connectors on its back edge. One is the aforementioned data bus. The other connector is a power connector. Both of these connectors are standard form factor and well known in the industry. One skilled in the art will readily recognize that other mass storage devices may be substituted for the disk drive, including but not limited to, optical devices and tape storage devices.

The CPU subsystem is composed of a microprocessor, memory and necessary peripherals, which include a disk controller capable of controlling the disk drive. In the preferred embodiment, this CPU subsystem is contained primarily in a type of ASIC (Application Specific Integrated Circuit) commonly referred to as a System On Chip (SOC). The SOC typically contains the main computing engine and may contain controllers for interfacing to most peripheral devices such as the disk and network. The CPU subsystem further contains memory chips required to provide adequate memory to support the operating system and application software that the CPU subsystem must be capable of running. Additional components are included as required to support these. Such components may include, but are not limited to: oscillator crystal, local power regulator block, and network interface transformer, as well as required connectors.

The CPU subsystem, in the preferred embodiment, contains connectors for the disk drive and is arranged in such a manner as to plug directly into the back of the disk drive. Hence, the disk drive receives both its data connection and power connection from the CPU subsystem. One skilled in the art will readily recognize that the connectors are optional, and that various other means of electrically coupling the CPU subsystem to the disk drive exist to form one monolithic unit, with no external interconnecting cables. The CPU subsystem further has connectors on the opposite surface to receive power from the power supply and a connection to the network that is to be served.

In the preferred embodiment, the CPU subsystem is contained in a metal enclosure that conforms to approximately the same height and width as the disk drive such that when coupled to the disk drive, the resulting server appears to be the same height and width as a standard disk drive, but with an extended length. This allows the server to fit into many standard disk drive mounting facilities. The aforementioned metal enclosure includes suitable brackets, ears, or other devices to mechanically secure the CPU subsystem and disk drive together to form the server.

A further object of the invention is the combination of two or more servers into a server farm. This is accomplished using a standard disk drive mounting rack cabinet or other hardware enclosure, and installing server units instead of bare disk drive units as would otherwise be done.

Some mounting designs accommodate easily removable carriers that contain the disk drives. This facilitates rapid replacement of failed units. These carriers may also accommodate the server.

The aforementioned disk enclosures typically contain a power supply, or perhaps redundant power supplies. Power from these power supplies is usually cabled to the disk drives utilizing standard disk drive power connectors. In the preferred embodiment, these same power supplies and cables are used, but connected to the CPU subsystem portion of the network server instead of to the disk drive. Recall that the CPU subsystem then provides power to the disk drive by “bussing” the power through from the incoming power connector to the disk drive power connector. The CPU subsystem also uses the power for its own needs.

Each network server includes at least one network connection. In the preferred embodiment, the network servers each have one network connection in the form of a 100BaseT (Fast Ethernet) connection, as well known in the industry. Each of these network connections is cabled to one or more 100BaseT hubs, and thence to a network router, load balancer or other suitable interface to the larger network being served.

In addition to connecting to the coupled disk drive, the CPU subsystem may connect to additional disk drives by means of extra connectors. This enables the CPU subsystem to support extended storage capability, including, but not limited to RAID arrays.

### BRIEF DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown, and wherein:

FIG. 1 is a diagram illustrating how the disk drive and CPU subsystem mate together

FIG. 2 is a block diagram of the CPU subsystem

FIG. 3 is a diagram illustrating how multiple network servers can be combined to form a server farm.

### DETAILED DESCRIPTION OF THE INVENTION SERVERS

The present invention couples a disk drive to a CPU subsystem to produce a single server unit capable of providing various services and functions. The preferred embodiment is described in terms of a network server. However, one skilled in the art will recognize that this same invention can be adapted to a number of alternative products including, but not limited to, multi-media servers, tape backup devices, and user interactive computers to serve a variety of needs, such as point of sale terminals, sales demonstration units, game devices, television and audio replay devices, as well as a variety of “set-top-box” applications for interfacing to cable systems satellite, or DSL systems.

Referring to FIG. 11, disk drive 100 has a height 105, a width 104 and a length 106. The disk drive is coupled to CPU subsystem 150. CPU subsystem is composed of a single board computer enclosed within a sheet metal housing. The housing has ears 153 on each side (only one shown). These ears slide over the side of the disk drive and align with corresponding holes 103 on each side of the disk drive (only one shown). These holes are typically threaded and accept screws so that the ears may be screwed to the disk drive thus mechanically coupling the two devices into one unit. Ideally, the form factor and size of the CPU subsystem is consistent with the disk drive such that the resulting unit approximates one rectangular shape, in essence a longer disk drive of extended length 107. This arrangement provides advantages in mounting and handling of the unit, particularly when a plurality of such units are aggregated together. This server unit may be mounted in many standard mounting enclosure without alteration of the enclosure. It should also be understood that the server unit may also be used in some removable disk systems, wherein a standard disk drive is mounted in a carrier that can then be easily plugged into a rack or other enclosure by the user, often requiring no tools.

Disk drive data bus socket 101 accepts a mating plug (not shown) that is incorporated into the CPU subsystem 150. Similarly, power socket 102 accepts a mating power plug (not shown) that is incorporated into the CPU subsystem 150.

CPU Subsystem 150 contains power socket 152 that accepts power from the power supply in the same manner as the disk drive normally does in designs other than this invention. Power supplied to socket 152 flows through the CPU Subsystem and is supplied to the disk drive via socket 102. CPU Subsystem 150 further includes a standard RJ-45 socket 151 used to connect to a conventional 100BaseT local area network. LED indicators 159 and system reset button 158 are not part of the invention, but are shown for completeness.

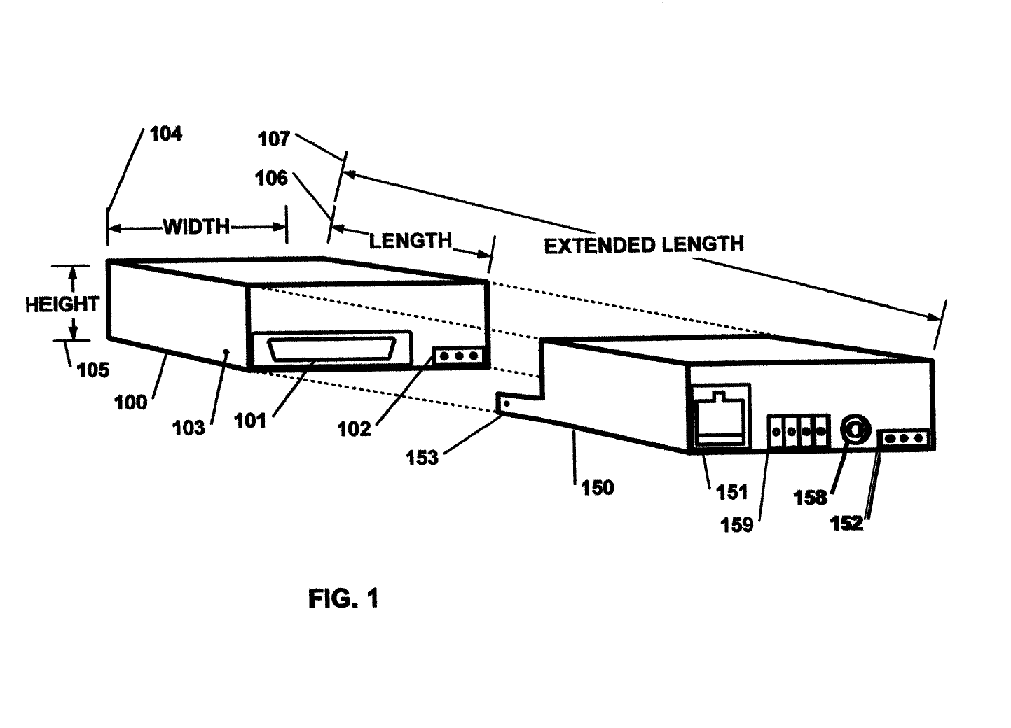

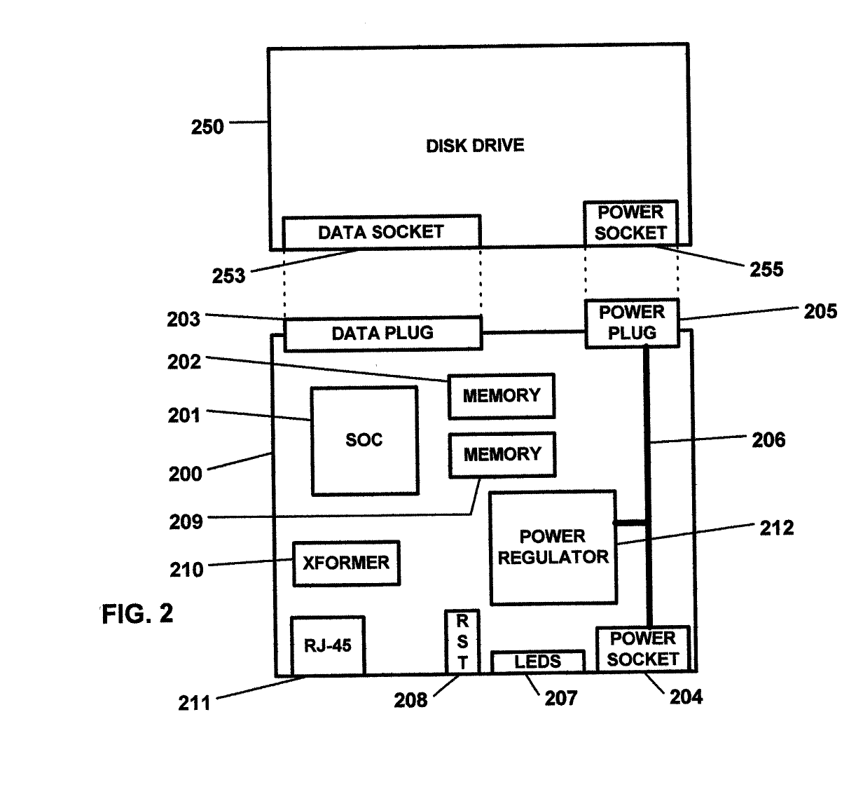

Referring to FIG. 2 a view of the computer circuit board 200 used in the preferred embodiment is shown. This circuit board 200 is housed within the enclosure 150 shown in FIG. 1. It mates to the disk drive 250, which is the same disk drive 100 illustrated in FIG. 1. Specifically, data plug 203 mates to data socket 253 and power plug 205 mates to power receptacle 255. One skilled in the art will readily recognize that alternative designs within the scope of the invention could eliminate the sockets 253 and 255 or plugs 203 and 205 by replacing them with alternate connections means. Likewise the plugs 203 and 205 need not be fixed to the circuit board 200; instead they could be connected to the circuit board via flexible cables to facilitate adaptation to minor variations of spacing of the sockets 253 and 255 between different brands of disk drives.

The SOC ASIC 201 is shown, which contains the main CPU, disk and network controllers as well as a number of other components. The preferred embodiment utilizes an AXIS ETRAX 100LX SOC from Axis Communications Inc. located at 100 Apollo Drive Chelmsford, Mass. 01824. The use of such a chip facilitates design of a powerful computer system that uses very little space, requires less power and cooling. These qualities allow the size of the CPU subsystem to be much smaller than the prior art solutions, this making the present invention more desirable.

While this SOC technology is desirable in producing optimal products based on this invention, it should be understood that the use of an SOC is neither a necessary requirement nor claimed as part of the invention.

Memory chips 202 and 209 provide the memory storage required for the CPU subsystem.

Network interface transformer 210 provides part of the 100BaseT network interface not contained within the SOC 201, and RJ-45 socket 211 provides the ability to connect the CPU subsystem 200 to the network. One skilled in the art will recognize that alternate applications might replace this connector or add additional connections to handle other interfaces, including, but not limited to, other types of local area networks, cable or DSL modem interfaces, wireless antennas, various user interface devices, such as terminals, monitors, keyboard and gaming input devices.

Power socket 204 receives power from the power supply. Power from socket 204 flows over power bus 206 to power plug 205 and thence to the disk drive power socket 255. This power “bus through” feature facilitates ease of construction and maintenance. The power from power bus 206 also supplies local power to the power regulator 212 which supplies regulated power to other CPU subsystem components at the various voltages needed.

LED indicators 207 and reset button 208 are not part of the invention, and are illustrated for completeness.

Not shown are miscellaneous additional components not material to the invention. These may be located on the top side of the circuit board and on the bottom side of the circuit board.

Server Farms

A server farm is a collection of servers of the present invention. Server farms range in size from a few servers to hundreds of servers. Servers comprising a server farm may be enclosed in one or more standard 18″ or 23″ racks, or may be contained in a variety of other enclosures including, but not limited to, desk top cabinets and media juke boxes. The present server invention, particularly when combined with the use of SOC technology, allows the packing of more servers into less total space, utilizing less power, and produced at a lower price. The aforementioned conformance of the server to standard disk drive height and width dimensions allows the server to be accommodated by standard enclosures originally designed to handle only disk drives.

The present invention includes aggregating a plurality of the aforementioned server units into a server farm.

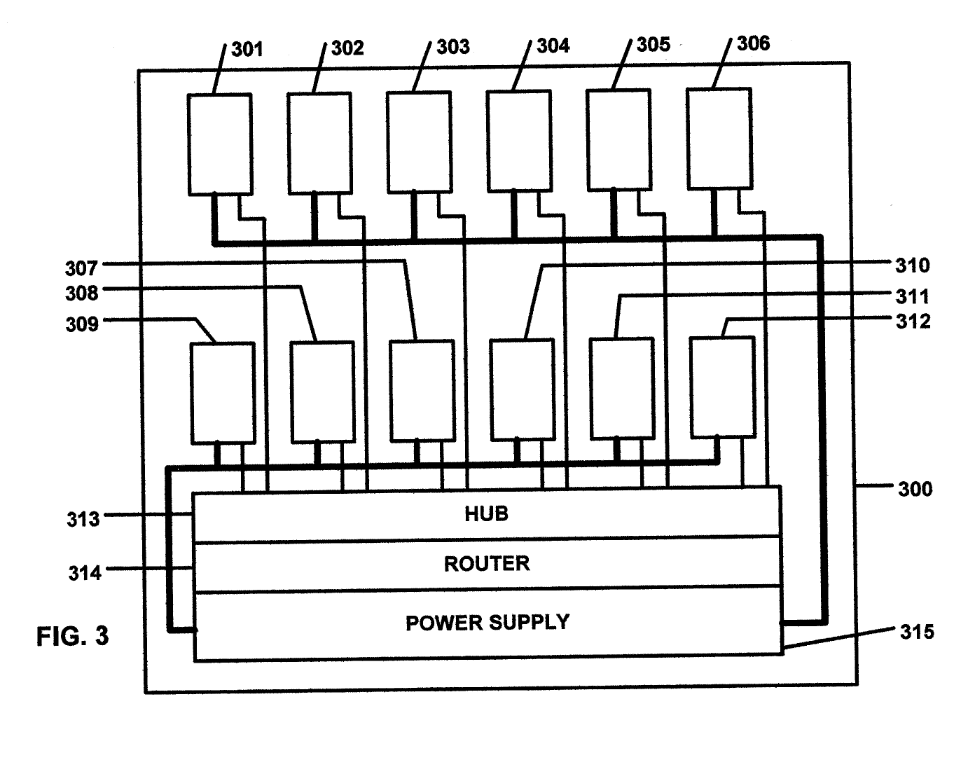

Referring to FIG. 3, in the preferred embodiment, enclosure 300 is a metal framework that screws into a standard 19″ rack. It should be understood that the invention anticipates the ability to vary the number of servers per enclosure to meet various market needs. Enclosure 300 contains servers 301 through 312. These twelve servers, 301 through 312 should be considered as illustrative of one alternative. It should be understood that a server farm may include one or more such enclosures. It should be further understood that all servers 301 through 312 do not need to be supplied in a particular enclosure.

Power supply 315 provides power to the servers 301 through 312 by way of two power harnesses 316 and 317. It should be understood that a variety of power supplies and harness arrangements is possible, including various redundant and isolated configurations. Cooling fans are contained within the power supplies and suitable venting (not shown) directs airflow over the power supplies and servers.

The 100BaseT hub 313 connects the servers 301 through 312 to router 314 that provides a number of possible features including but not limited to firewall protection and load balancing between the servers. It should be understood that the router is optional, and that alternate configurations may utilize one larger hub for multiple enclosures. Furthermore, various alternative networking equipment may be used such as an Ethernet switch.

In the preferred embodiment, additional disks may be supported, by connecting them to a data control bus that is controlled by the SOC 201. Connection to this bus is available via a data bus socket (not shown) similar to 253 and which is mounted on the underside of the circuit board 200. A standard ribbon cable can be connected from that socket to the additional disk drives. It should be understood that the resulting plurality of disk drives may be operated by the software in a number of configurations including, but not limited to, additional file systems, volumes, and RAID arrays.

Server farms may provide for redundancy of servers such that one or more redundant servers may take over for one or more failing primary servers. A variety of redundancy mechanisms are well known in the art. Examples include warm-standby and one-for-N fail-over. Redundancy mechanisms are typically implemented largely in software and coordination among cooperating servers is required. The specific redundancy mechanism is not the object of the present invention. The present invention supports implementation of various redundancy mechanisms via the network control port 151 illustrated in FIG. 1. Messages may be sent between the cooperating servers to via this port 151 to achieve the redundancy mechanism.

Similarly, server farms may provide for load sharing among servers. A variety of load sharing mechanism are well known in the art. These include, but are not limited to, distributed load mechanisms, parallel computing mechanisms, load balancers, and job schedulers. The specific redundancy mechanism is not the object of the present invention. The present invention supports implementation of various load sharing mechanisms via the network control port 151 illustrated in FIG. 1. Messages may be sent between the cooperating servers, and perhaps other equipment, via this port 151 to achieve the load sharing mechanism.

I claim:

1. A system for providing a server comprising:
a disk drive and
a CPU subsystem mechanically coupled directly to said disk drive and
conforming approximately to the height and width of disk drive and
a connection between said CPU subsystem and said disk drive control bus requiring no external wires or cables and
a connection between said CPU subsystem and said disk driver to provide power to said disk drive from said CPU subsystem requiring no external wires or cables.

2. A system of claim 1 and further comprising:
an electrical disk bus connection from said CPU subsystem to at least one additional disk drive.

3. A system of claim 2 where the disks are arranged to operate as a RAID disk array.

4 A server farm system consisting of at least two servers of claim 1 contained in a single enclosure.

5 A server farm system consisting of at least two servers of claim of 3 contained in a single enclosure.

6 A server farm system where at least one system of claim 1 is used to provide redundancy for at least one other system of claim 1.

7 A server farm system where two or more systems of claim 1 are used to share a server load.

8 A method of providing network services, said method comprising the steps of:
providing a disk drive and CPU subsystem;
arranging the CPU subsystem to mechanically couple directly to the disk drive;
conforming to the approximate height and width of disk drive;
providing a connection between said CPU subsystem and said disk drive control bus requiring no external wires or cables;
providing power to the disk drive from the CPU subsystem requiring no external wires or cables.

9 A method of claim 8 and further comprising the step of
connecting the disk data bus connection to at least one additional disk drive from said CPU subsystem.

10 A method of claim 9 and further comprising the step of operating the plurality of disks as a RAID array.

11 A method of providing a server farm system comprising the step of containing at least two servers of claim 8 in a single enclosure.

12. A method of providing a server farm system comprising the step of containing at least two servers of claim 9 in a single enclosure.

13. A method of providing redundancy comprising the steps of
a) Providing at least one primary server of claim 8
b) Providing at least one redundant server of claim 8
c) Providing a network connection between at least one primary server and one at least one redundant server.
d) Providing software capable of providing a redundant operation

14. A method of providing load sharing comprising the steps of
a) Providing at least two servers of claim 8
b) Providing a network connection between at least two of the servers.
c) Providing software capable of providing a redundant operation

15. A server comprising:
means for coupling CPU subsystem to a disk drive where:
a) the CPU subsystem is mechanically affixed to the disk drive
b) conforming to approximate height and width of disk drive
c) a connection between said CPU subsystem and said disk drive control bus requiring no external wires or cables
d) a connection between said CPU subsystem and said disk driver to provide power to said disk drive from said CPU subsystem requiring no external wires or cables.

16. A system of claim 15 and further comprising a means for connecting an electrical disk bus connection from said CPU subsystem to at least one additional disk drive.

17. A system of claim 16 wherein a means is provided to arrange the plurality of disks to operate as a RAID disk array.

18. A means for creating a server farm system consisting of at least two servers of claim 15 or of claim 16.

19. A means for providing redundancy where at least one redundant server of claim 15 provides redundancy for at least one primary server.

20. A means for providing load sharing where at least two servers of claim 15 provide services.
